(19) United States
(12) Patent Application Publication
(10) Pub. No.: US 2025/0322663 A1
(43) Pub. Date: Oct. 16, 2025

(54) METHOD AND SYSTEM TO PROVIDE ALARM RISK SCORE ANALYSIS AND INTELLIGENCE

(71) Applicant: Tyco Fire & Security GmbH, Neuhausen am Rheinfall (CH)

(72) Inventors: Gopal PARIPALLY, North Andover, MA (US); Brian RICHARD, Westford, MA (US); Umesh CHAWLA, Hyderabad (IN); Rick FOCKE, Andover, MA (US)

(21) Appl. No.: 18/878,578

(22) PCT Filed: Jun. 30, 2023
(86) PCT No.: PCT/US2023/069514

§ 371 Date: Dec. 23, 2024

Related U.S. Application Data
(60) Provisional application No. 63/359,050, filed on Jul. 7, 2022.

(51) Int. Cl. G06V 20/52; G06V 10/70; G06V 20/40; G08B 13/196

(52) U.S. Cl. CPC G06V 20/52; G06V 10/70; G06V 20/40; G08B 13/196

(57) ABSTRACT

A system may be configured to provide alarm risk score intelligence and analysis. In some aspects, the system may receive sensor information captured by one or more sensors, the sensor information indicating activity within a controlled environment, and determine an event based on the sensor information. Further, the system may receive one or more video frames from one or more video capture devices and determine context information based on the one or more video frames. Additionally, the system may modify the event based on the context information to generate an alarm and transmit a notification identifying the alarm to a monitoring device.

### CROSS REFERENCE TO RELATED APPLICATION(S)

This application is a U.S. National Stage under 35 U.S.C. § 371 of International Application No. PCT/US2023/069514, as filed on Jun. 30, 2023, which is based on and claims the priority to the U.S. Provisional Patent Application No. 63/359,050, entitled “METHOD AND SYSTEM TO PROVIDE ALARM RISK SCORE ANALYSIS AND INTELLIGENCE” and filed on Jul. 7, 2022. The disclosure of each of these applications is incorporated by reference herein in their entireties.

### BACKGROUND

### Technical Field

In some controlled environments (e.g., buildings), operators may employ monitoring system to detect different types of events occurring within the controlled environment (e.g., unauthorized access to a room). For example, an operator may deploy sensors throughout a controlled environment for monitoring the movement of people within the controlled environment. Further, a monitoring system may receive the monitoring information and generate alarms based on preconfigured rules. As the complexity and diversity of sensor devices increases, the amount of information collected by sensor devices during events within a controlled environment may exponentially increase. Further, it may be difficult and inefficient to determine which events should be prioritized based solely on the sensor information and rules.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The present disclosure provides systems, apparatuses, and methods for providing alarm risk score intelligence and analysis. In an aspect, a method for receiving sensor information captured by one or more sensors, the sensor information indicating activity within a controlled environment; determining an event based on the sensor information; receiving one or more video frames from one or more video capture devices; determining context information based on the one or more video frames information; modifying the event based on the context information to generate an alarm; and transmitting a notification identifying the alarm to a monitoring device.

The present disclosure includes a system having devices, components, and modules corresponding to the steps of the described methods, and a computer-readable medium (e.g., a non-transitory computer-readable medium) having instructions executable by a processor to perform the described methods.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram a system for providing alarm risk score intelligence and analysis, according to some implementations.

FIG. 2 is a flow diagram of an example of a method of providing alarm risk score intelligence and analysis, according to some implementations.

FIG. 3 is block diagram of an example of a computer device configured to implement a system for providing alarm risk score intelligence and analysis, according to some implementations.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

Implementations of the present disclosure provide alarm risk score intelligence and analysis. In some implementations, one problem solved by the present solution is sensor and event information overload in monitoring systems, which can lead to operators overlooking or ignoring vital alerts and introduce gross inefficiency by requiring cumbersome processing of inconsequential sensor and event information. For example, this present disclosure describes systems and methods that employ computer vision and/or machine learning (ML) to help distinguish between events that require immediate attention and events that do not require immediate attention.

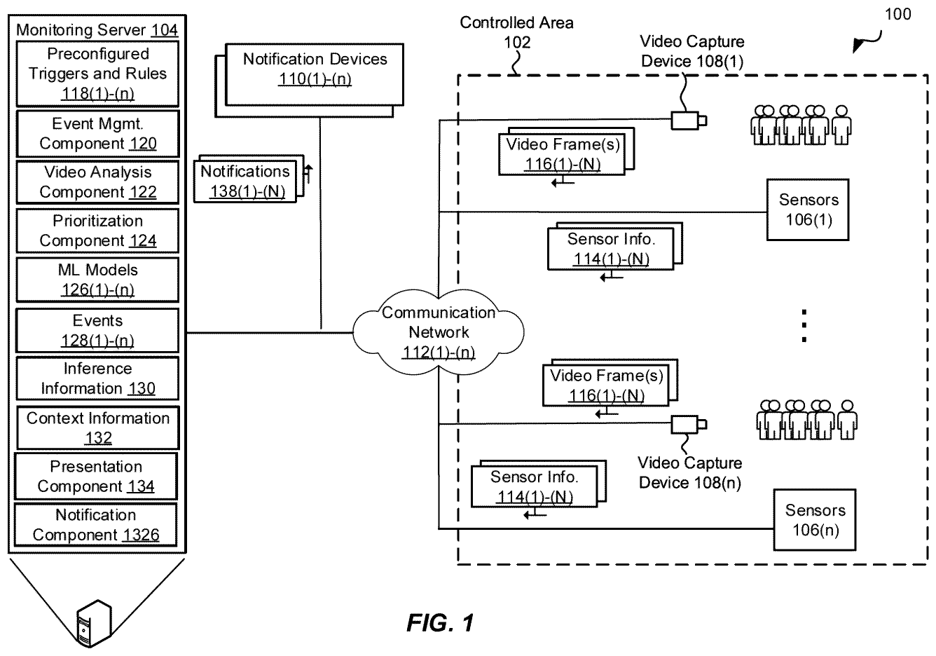

Referring to FIG. 1, in one non-limiting aspect, an alarm system 100 is configured to monitor activity within and/or around a controlled area 102, and generate concise alarm information based on video feed data. For example, system 100 is configured to capture sensor information and video feed data, determine event information from the sensor information, determine context information from the video feed data, and analyze the sensor information in view of the context information to generate accurate and concise alarm information.

As illustrated in FIG. 1, the alarm system 100 may include a monitoring server 104, one or more sensors 106 1)-(n), one or more video capture devices 108(1)-(n), one or more notification devices 110(1)-(n), and/or one or more communication networks 112(1)-(n). Further, the one or more sensors 106(1)-(n) and/or the one or more video capture devices 108(1)-(n) may be positioned in different areas of the controlled area 102. In some implementations, a communication network 112 may include a plain old telephone system (POTS), a radio network, a cellular network, an electrical power line communication system, one or more of a wired and/or wireless private network, personal area network, local area network, wide area network, and/or the Internet. Further, in some aspects, the monitoring server 104, the one or more sensors 106(1)-(n), the one or more video capture devices 108(1)-(n), and the one or more notification devices 110(1)-(n) may be configured to communicate via the communication networks 112(1)-(n).

In some aspects, the one or more sensors 106(1)-(n) may capture sensor information 114 and transmit the sensor information 114 to the monitoring server 104 via the communications network 112(1)-(n). Some examples of the one or more sensors 106(1)-(n) include lidar sensors, radar sensors, occupancy sensors, environmental sensors, door sensors, entry sensors, exit sensors, people counting sensors, temperature sensors, liquid sensors, motion sensors, light sensors, gas sensors, location sensors, carbon monoxide sensors, smoke sensors, pulse sensors, etc. In some aspects, the video capture devices 108(1)-(n) may capture one or more video frames 116(1)-(n) of activity within the controlled area 102, and transmit the one or more video frames 116(1)-(n) to the monitoring server 104 via the communications network 112(1)-(n). Some examples of the notification devices 110(1)-(n) include smartphones and computing devices, Internet of Things (IoT) devices, video game systems, robots, process automation equipment, control devices, vehicles, transportation equipment, virtual and augmented reality (VR and AR) devices, industrial machines, audio alarm devices, a strobe or flashing light devices, etc.

The monitoring server 104 may be configured to monitor the controlled area 102 and trigger alarms based upon one or more preconfigured triggers and rules 118(1)-(n). As illustrated in FIG. 1, the monitoring server 104 may include an event management component 120, a video analysis component 122, a prioritization component 124, and one or more ML models 126(1)-(n). In some aspects, the event management component 120 may identify and/or detect events 128(1)-(n) based upon the sensor information 114 received from the one or more sensors 106(1)-(n). In some examples, the sensor information 114 may identify events 128(1)-(n) detected at the one or more sensors 106(1)-(n). For instance, the event management component 120 may receive an event indicating that a door has been forced open, a door has been held opened, access to an entryway has been denied, access to an entryway has been granted, badge access to an entryway has been denied, badge access to an entryway has been granted, identification of a person of interest, use of a suspicious badge, suspicious operator patterns, suspicious credential usage, suspicious badge creation patterns, multiple failures to authenticate using a physical credential (e.g., badge), hardware communication failure, and/or multiple occurrences of at least one of the preceding event types in a common location. Some examples of suspicious badge usage may include a number of badge rejections above a predefined threshold, abnormal usage based on the normal activity of the badge holder (e.g., badge use at a location infrequently accessed by the badge holder, badge use during a time period not associated with typical usage by the badge holder), a number of badge rejections above a predefined threshold within a predefined period of time at a same location, a number of badge rejections above a predefined threshold at two or more locations within a predefined distance of each other, a number of badge rejections above a predefined threshold by a particular badge holder, and/or a number of badge rejections above a predefined threshold having a particular reason for denial at a particular location and/or during a particular period in time. Further, in some aspects, the suspicious badge usage may be used to determine a dynamic value to modify a risk value corresponding to the badge rejection.

Additionally, or alternatively, in some examples, the event management component 120 may detect an event based upon the sensor information 114 received from the one or more sensors 106(1)-(n). In some examples, the event management component 120 may receive a sensor reading from a sensor 106, and generate an event 128 indicating that a door has been forced open, a door has been held open, access to an entryway has been denied, access to an entryway has been granted, identification of a person of interest, use of a suspicious badge, and/or hardware communication failure. As another example, the event management component 120 may receive a sensor reading including a temperature of a location within the controlled area 102 from a sensor 106, and generate a fire event.

In some examples, an event 128 may be associated with a risk value indicating a perceived threat level of an activity and/or a state represented by a sensor reading and/or collection of sensor readings within the sensor information 114 or a probability level of an activity and/or a state represented by a sensor reading and/or collection of sensor readings within the sensor information 114. For example, a door forced open event at a backdoor of the controlled area 102 may trigger a risk value of eighty-five. Further, the risk value for each different type of event may be configured by an operator of the monitoring server 104. In some aspects, the event management component 120 may employ the one or more ML models 126(1)-(n) to identify and/or detect events 128(1)-(n) based upon the sensor information 114. The ML models 126(1)-(n) may be deep learning models or any other types of ML models and/or pattern recognition algorithms, e.g., random forest, neural network, etc.

The video analysis component 122 may generate inference information 130(1)-(n) based on the one or more video frames 116(1)-(n), and generate context information 132(1)-(n) using the inference information 130(1)-(n). In some aspects, the video analysis component 122 may detect faces in the one or more video frames 116(1)-(n) received from the video capture devices 108(1)-(n), and generate inference information including the detected faces. For instance, the video analysis component 122 may identify a face within the one or more video frames 116(1) based at least in part on the one or more ML models 126 configured to identify facial landmarks within a video frame. The video analysis component 122 may track objects between the one or more video frames 116(1)-(n), and generate inference information 130 including the detected movement. For example, the video analysis component 122 may generate tracking information indicating movement of a person between the one or more video frames 116(1)-(n). In some aspects, the video analysis component 122 may determine a bounding box for the person and track the movement of the bounding box between successive one or more video frames 116. In some aspects, the video analysis component 122 may employ the one or more ML models 126(1)-(n) to generate the bounding boxes corresponding to people within the controlled area 102. Further, the video analysis component 122 may determine path information for people within the controlled area 102 based at least in part on the tracking information, and generate inference information including the path information. As an example, the video analysis component 122 may generate path information indicating the journey of the person throughout the controlled area 102 based upon the movement of the person between successive video frames 116. In addition, the video analysis component 122 may be able to determine a wait time indicating the amount of time a person has spent in a particular area, and an engagement time indicating the amount of time a person has spent interacting another person and/or object. Further, the video analysis component 122 may be configured to generate a journey representation indicating the journey of a person through the controlled area 102 with information indicating the duration of the journey of the person within the controlled area 102, and the amount of time the person spent at different areas within the controlled area 102. Additionally, the video analysis component 122 may generate inference information 130 including the journey representation. In some aspects, the video analysis component 122 may determine the wait time and the engagement time based at least in part on bounding boxes. For instance, the video analysis component 122 may determine a first bounding box corresponding to a person and a second bounding box corresponding to another person and/or an object. In addition, the video analysis component 122 may monitor the distance between the first bounding box and the second bounding box. In some aspects, when the distance between the first bounding box and the second bounding box as determined by the video analysis component 122 is less than a threshold, the video analysis component 122 may determine that a person is engaged with another person and/or an object. In addition, the video analysis component 122 may further rely on body language and gaze to determine whether a person is engaged with another person and/or an object. Further, the video analysis component 122 may determine path information based at least in part on the one or more ML models 126(1)-(n) configured to generate and track bounding boxes.

The video analysis component 122 may determine the amount of people that enter and exit the controlled area 102 based on the one or more video frames 116(1)-(n). In particular, the one or more of the video capture devices 108(1)-(n) may be positioned to capture activity by entry ways and exits of the controlled area 102. Further, in some aspects, the video analysis component 122 may identify people in the one or more video frames 116(1)-(n), and determine the direction of the movement of the people and whether the people have traveled past predefined locations corresponding to entry to and exit from the controlled area 102. The video analysis component 122 may determine one or more attributes of people within the controlled area 102 based on the one or more video frames 116(1)-(n) received from the video capture devices 108(1)-(n), and generate inference information describing the one or more attributes of the people within the controlled area 102. For instance, the video analysis component 122 may predict the age, gender, emotion, sentiment, body language, emotion, and/or gaze direction of a person within a video frame 116 (1), and generate inference information 130 including the determined attribute information. Further, the video analysis component 122 may employ the one or more ML models 126(1)-(n) and/or pattern recognition techniques to determine attributes of the people within the controlled area 102 based on the one or more video frames 116(1)-(n).

In addition, in some aspects, the video analysis component 122 may determine an operational status of the video capture devices 108(1)-(n). For example, the video analysis component 122 may determine whether a camera is offline, obstructed, or partially obstructed. Further, the video analysis component 122 may employ the one or more ML models 126(1)-(n) and/or pattern recognition techniques to determine the operational status of the video capture devices 108(1)-(n) based on the one or more video frames 116(1)-(n).

The video analysis component 122 may generate context information 132 based at least in part on the inference information 130. In some examples, the context information 132 may be a dynamic value indicating a perceived threat level of an activity and/or a state represented by the inference determined by the video analysis component 122 or a probability level of an activity and/or a state represented by the inference determined by the video analysis component 122. For example, the inference information 130 may indicate that more than ten people have entered through the back door of the controlled area 102. Further, the video analysis component 122 may determine that the dynamic value of the activity at the backdoor is forty-five.

The prioritization component 124 may be configured to perform alarm escalation/prioritization and reduction based on the events 128, the context information 132, and other relevant information (e.g., scheduling information for the controlled area 102, planned gatherings at the controlled area 102, etc.). For instance, the prioritization component 124 may receive an event from the event management component 120 and modify the event based on output of the video analysis component 122 to determine whether to trigger an alarm or prioritize notification of the event. For example, the prioritization component may receive a risk value of eighty-five from the event management component 120 in connection with a door being forced open at a particular location. Further, the prioritization component 124 may determine that a dynamic value of forty-five corresponds to inference information generated by the video analysis component indicating that more than ten people entered the door at the particular location. In addition, the prioritization component 124 may add the risk value and the dynamic value based upon the shared associated with the particular location, and determine that the sum of the risk value and the dynamic value is greater than one or more predefined alarm thresholds. For example, if the sum is greater than a first predefined threshold set forth in the one or more preconfigured triggers and rules 118(1)-(n), the prioritization component 124 may trigger an alarm and request that an operator acknowledge receipt of the alarm. In another example, if the sum is greater than a second predefined threshold set forth in the one or more preconfigured triggers and rules 118(1)-(n), the prioritization component 124 may trigger an alarm without requesting that an operator acknowledge receipt of the alarm. In yet still another example, if the sum is less than a third predefined threshold set forth in the one or more preconfigured triggers and rules 118(1)-(n), the prioritization component 124 may record the sum without triggering an alarm. For example, the prioritization component 124 may auto-acknowledge or automatically clear an event without triggering an alarm. Further, the application of the dynamic value should be logged. For example, the risk value, the dynamic value, and/or an underlying rule corresponding to the dynamic value may be logged for subsequent review.

Additionally, or alternatively, in some aspects, the prioritization component 124 may further employ historic or related event information or attribute information of objects within the controlled area 102 (e.g., door criticality, door location, door grouping) when determining the dynamic value. For instance, the context information may be based at least in part event information or attribute information related to a location within the controlled area 102 and/or a device within the controlled area 102. For example, the risk value of a communication failure event may be lowered by a dynamic value related to the restart of the one or more components of the monitoring server 104. As another example, the risk value of a communication failure event may be lowered by a dynamic value related to the number of communication devices in a failure context being less than a predefined threshold. As another example, a door being forced open a certain number of times within a predefined time period may modify the risk value corresponding to a door forced open event, especially when the door is considered to be critical, related to a high value location, or has another attribute of import. As another example, a risk value corresponding to a door forced open event may be modified by a schedule indicating a security level of one or more time periods. For instance, a security level may be heightened during the visit of a public official during a particular period of time. Further, a risk value corresponding to a door forced open event may be raised by a dynamic value corresponding to the door being force open during the particular period time and/or at a location related to the presence of the public official. As another example, an authorized admission to a secured space within the controlled area 102 may modify the risk value of a door forced open event, especially when the door status is subsequently returned to normal. As yet still another example, a risk value corresponding to a door force open event may be raised by a dynamic value corresponding to an obstructed video capture device 108 within the vicinity of the door that has been forced open.

In some aspects, the monitoring server 104 may include a presentation component 134 and/or a notification component 136 configured to notify operators and/or administrators of event and alarms. For example, if an alarm is triggered, the presentation component 134 may present a graphical user interface (GUI) displaying a notification identifying the alarm and related information (e.g., location, time of the underlying event, audio, video, and/or pictures of the event, a responsible party for the location or event type). In some aspects, the GUI may sort a list of events detected within the controlled area 102 and display the alarms in a prioritized fashion. Further, if an alarm is triggered, the notification component 136 may transmit alarm notifications 138(1)-(n) to the notification devices 110(1)-(n). In some instances, the alarm notifications 138(1)-(n) may be a visual notification, audible notification, or electronic communication (e.g., text message, email, etc.) to the notification devices 110(1)-(n).

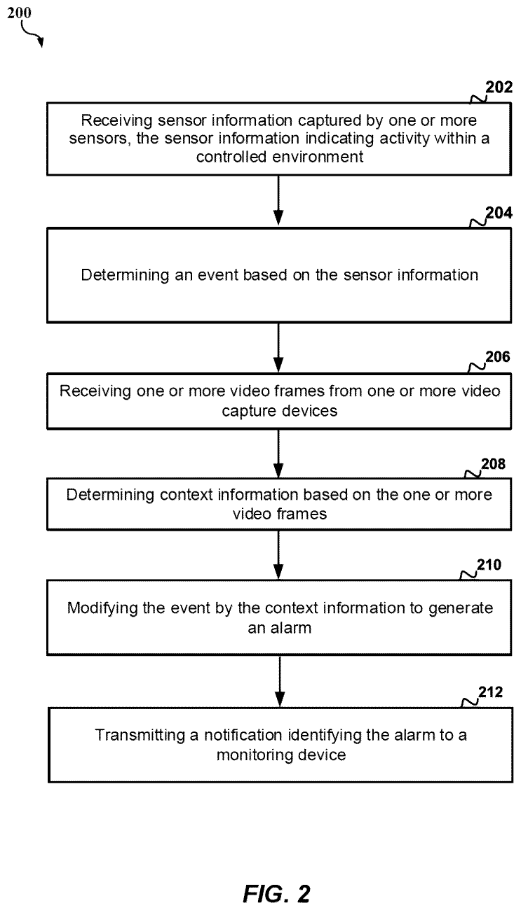

Referring to FIG. 2, in operation, the monitoring server 104 or computing device 300 may perform an example method 200 for providing alarm risk score intelligence and analysis. The method 200 may be performed by one or more components of the monitoring server 104, the computing device 300, or any device/component described herein according to the techniques described with reference to FIG. 1.

At block 202, the method 200 includes receiving sensor information captured by one or more sensors, the sensor information indicating activity within a controlled environment. For example, the one or more sensor devices 106(1)-(n) may capture sensor information 114 and transmit the sensor information 114 to the event management component 120. Accordingly, the monitoring server 104, the computing device 300, and/or the processor 302 executing the event management component 120 may provide means for receiving sensor information captured by one or more sensors, the sensor information indicating activity within a controlled environment.

At block 204, the method 200 includes determining an event based on the sensor information. For example, the event management component 120 may detect an event 128 having a corresponding risk value based on the sensor information 114. Accordingly, the monitoring server 104, the computing device 300, and/or the processor 302 executing the event management component 120 may provide means for determining an event based on the sensor information.

At block 206, the method 200 includes receiving one or more video frames from one or more video capture devices. For example, the one or more sensor devices 106(1)-(n) may capture sensor information 114 and transmit the sensor information 114 to the video analysis component 122. Accordingly, the monitoring server 104, the computing device 300, and/or the processor 302 executing the video analysis component 122 may provide means for receiving one or more video frames from one or more video capture devices.

At block 208, the method 200 includes determining context information based on the one or more video frames. For example, the video analysis component 122 may determine inference information 130 based on one or more video frames 116, and generate context information 132 (e.g., dynamic value) based on the inference information 130. Accordingly, the monitoring server 104, the computing device 300, and/or the processor 302 executing the video analysis component 122 may provide means for determining context information 132 based on the one or more video frame.

At block 210, the method 200 includes modifying the event based on the context information to generate an alarm. For example, the prioritization component 124 may combine the risk value and the dynamic value. Further, if the combination of the risk value and the dynamic value is greater than a predefined value, the prioritization component 124 may trigger an alarm. Accordingly, the monitoring server 104, the computing device 300, and/or the processor 302 executing the prioritization component 124 may provide means for modifying the event based on the context information to generate an alarm.

At block 212, the method 200 includes transmitting a notification identifying the alarm to a monitoring device. For example, if an alarm is triggered, the presentation component 134 may present a graphical user interface (GUI) displaying a notification identifying the alarm. As another example, if an alarm is triggered, the notification component 136 may transmit alarm notifications 136(1)-(n) to the notification devices 110(1)-(n). Accordingly, the monitoring server 104, the computing device 300, and/or the processor 302 executing the presentation component 134 and/or the notification component 136 may provide means for transmitting a notification 138 identifying the alarm to a monitoring device.

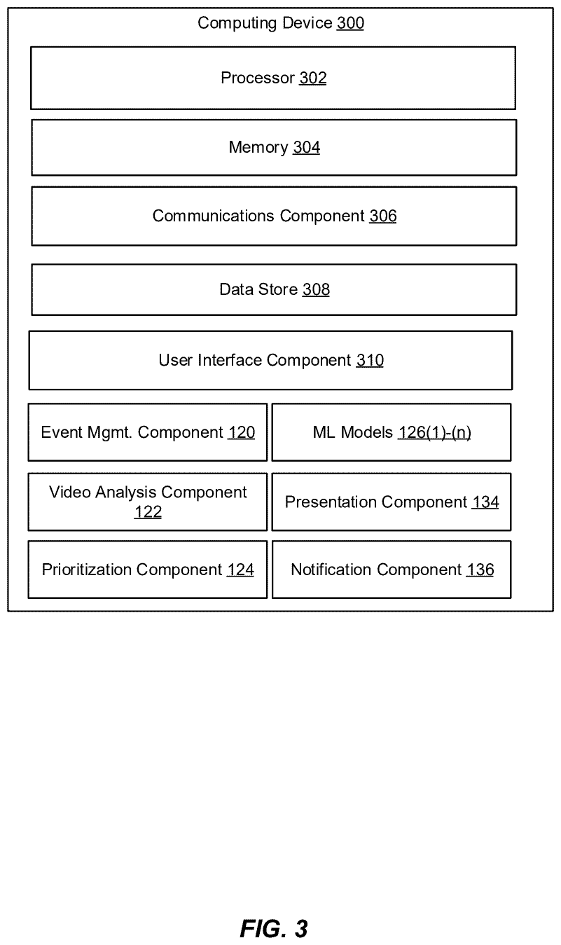

Referring to FIG. 3, a computing device 300 may implement all or a portion of the functionality described herein. The computing device 300 may be or may include or may be configured to implement the functionality of at least a portion of the alarm system 100, or any component therein. For example, the computing device 300 may be or may include or may be configured to implement the functionality of the event management component 120, the video analysis component 122, the prioritization component 124, the one or more ML models 126(1)-(n), the presentation component 134 and/or the notification component 136. The computing device 300 includes a processor 302 which may be configured to execute or implement software, hardware, and/or firmware modules that perform any functionality described herein. For example, the processor 302 may be configured to execute or implement software, hardware, and/or firmware modules that perform any functionality described herein with reference to the event management component 120, the video analysis component 122, the prioritization component 124, the one or more ML models 126(1)-(n), the presentation component 134, the notification component 136, or any other component/system/device described herein.

The processor 302 may be a micro-controller, an application-specific integrated circuit (ASIC), a digital signal processor (DSP), or a field-programmable gate array (FPGA), and/or may include a single or multiple set of processors or multi-core processors. Moreover, the processor 302 may be implemented as an integrated processing system and/or a distributed processing system. The computing device 300 may further include a memory 304, such as for storing local versions of applications being executed by the processor 302, related instructions, parameters, etc. The memory 304 may include a type of memory usable by a computer, such as random access memory (RAM), read only memory (ROM), tapes, magnetic discs, optical discs, volatile memory, non-volatile memory, and any combination thereof. Additionally, the processor 302 and the memory 304 may include and execute an operating system executing on the processor 302, one or more applications, display drivers, etc., and/or other components of the computing device 300.

Further, the computing device 300 may include a communications component 306 that provides for establishing and maintaining communications with one or more other devices, parties, entities, etc. utilizing hardware, software, and services. The communications component 306 may carry communications between components on the computing device 300, as well as between the computing device 300 and external devices, such as devices located across a communications network and/or devices serially or locally connected to the computing device 300. In an aspect, for example, the communications component 306 may include one or more buses, and may further include transmit chain components and receive chain components associated with a wireless or wired transmitter and receiver, respectively, operable for interfacing with external devices.

Additionally, the computing device 300 may include a data store 308, which can be any suitable combination of hardware and/or software, that provides for mass storage of information, databases, and programs. For example, the data store 308 may be or may include a data repository for applications and/or related parameters not currently being executed by processor 302. In addition, the data store 308 may be a data repository for an operating system, application, display driver, etc., executing on the processor 302, and/or one or more other components of the computing device 300.

The computing device 300 may also include a user interface component 310 operable to receive inputs from a user of the computing device 300 and further operable to generate outputs for presentation to the user (e.g., via a display interface to a display device). The user interface component 310 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 310 may include one or more output devices, including but not limited to a display interface, a speaker, a haptic feedback mechanism, a printer, any other mechanism capable of presenting an output to a user, or any combination thereof.

The present disclosure includes aspects from one or any combination of the following clauses.

Clause 1. A method comprising: receiving sensor information captured by one or more sensors, the sensor information indicating activity within a controlled environment; determining an event based on the sensor information; receiving one or more video frames from one or more video capture devices; determining context information based on the one or more video frames; modifying the event based on the context information to generate an alarm; and transmitting a notification identifying the alarm to a monitoring device.

Clause 2. The method of clause 1, wherein the event is associated with a risk value and the context information is a dynamic value, and modifying the event comprises: generating a threat value by adding the dynamic value to the risk value or subtracting the dynamic value from the risk value; determining that the threat value is greater than a predefined threshold; and generating the alarm based on the threat value being greater than the predefined threshold.

Clause 3. The method of clause 1, wherein the event is associated with a risk value and the context information is a dynamic value, and modifying the event comprises: generating a threat value by adding the dynamic value to the risk value or subtracting the dynamic value from the risk value; determining that the threat value is less than a predefined threshold; and generating the alarm based on the threat value being less than the predefined threshold.

Clause 4. The method of clause 1, wherein determining the event based on the sensor information comprises determining, based on a machine learning model and the sensor information, the event based on the sensor information.

Clause 5. The method of clause 1, wherein determining context information comprises determining, based on a machine learning model and the one or more video frames, the context information.

Clause 6. The method of clause 1, wherein determining context information comprises at least one of: identifying one or more persons within the one or more video frames; identifying one or more attributes of one or more person within the one or more video frames; identifying an activity being performed within the one or more video frames; identifying an object within the one or more video frames; identifying a number of objects within the one or more video frames; or identifying an environmental condition of a location within the one or more video frames.

Clause 7. The method of clause 1, wherein determining the context information comprises determining an operational status of the one or more video capture devices.

Clause 8. The method of clause 1, wherein the one or more sensors include occupancy sensors, environmental sensors, door sensors, entry sensors, exit sensors, people counting sensors, temperature sensors, liquid sensors, motion sensors, light sensors, carbon monoxide sensors, smoke sensors, gas sensors, location sensors, and/or pulse sensors.

Clause 9. A system comprising: one or more video capture devices; one or more sensors; and a monitoring platform comprising: a memory; and at least one processor coupled to the memory and configured to: receive sensor information from the one or more sensors, the sensor information indicating activity within a controlled environment; determine an event based on the sensor information; receive one or more video frames from the one or more video capture devices; determine context information based on the one or more video frames; modify the event by the context information to generate an alarm; and transmit a notification identifying the alarm to a monitoring device.

Clause 10. The system of clause 9, wherein the event is a risk value, the context information is a dynamic value, and to modify the event, the at least one processor is configured to: generate a threat value by adding the dynamic value to the risk value or subtracting the dynamic value from the risk value; determine that the threat value is greater than a predefined threshold; and generate the alarm based on the threat value being greater than the predefined threshold.

Clause 11. The system of clause 9, wherein the event is a risk value, the context information is a dynamic value, and to modify the event, the at least one processor is configured to: generate a threat value by adding the dynamic value to the risk value or subtracting the dynamic value from the risk value; determine that the threat value is less than a predefined threshold; and clear the event based on the threat value being less than the predefined threshold.

Clause 12. The system of clause 9, wherein to determine the event based on the sensor information, the at least one processor is configured to: determine, based on a machine learning model, the event based on the sensor information.

Clause 13. The system of clause 9, wherein to determine context information, the at least one processor is configured to: determine, based on a machine learning model, the context information.

Clause 14. The system of clause 9, wherein to determine the context information, the at least one processor is configured to: identify one or more persons within the one or more video frames; identify one or more attributes of one or more person within the one or more video frames; identify an activity being performed within the one or more video frames; identify an object within the one or more video frames; identify a number of objects within the one of more video frames; and/or identify an environmental condition of a location within the one or more video frames.

Clause 15. The system of clause 9, wherein to determine context information, the at least one processor coupled to the memory and configured to: determine an operational status of the one or more video capture devices.

Clause 16. The system of clause 9, wherein the one or more sensors include occupancy sensors, environmental sensors, door sensors, entry sensors, exit sensors, people counting sensors, temperature sensors, liquid sensors, motion sensors, carbon monoxide sensors, smoke sensors, light sensors, gas sensors, location sensors, and/or pulse sensors.

Clause 17. A non-transitory computer-readable storage medium storing instructions that cause a processor to perform the method of clauses 1-8.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method comprising:
receiving sensor information captured by one or more sensors, the sensor information indicating activity within a controlled environment;
determining an event based on the sensor information;
receiving one or more video frames from one or more video capture devices;
determining context information based on the one or more video frames;
modifying the event based on the context information to generate an alarm; and
transmitting a notification identifying the alarm to a monitoring device.

2. The method of claim 1, wherein the event is associated with a risk value and the context information is a dynamic value, and modifying the event comprises:
generating a threat value by adding the dynamic value to the risk value or subtracting the dynamic value from the risk value;
determining that the threat value is greater than a predefined threshold; and
generating the alarm based on the threat value being greater than the predefined threshold.

3. The method of claim 1, wherein the event is associated with a risk value and the context information is a dynamic value, and modifying the event comprises:
generating a threat value by adding the dynamic value to the risk value or subtracting the dynamic value from the risk value;
determining that the threat value is less than a predefined threshold; and
generating the alarm based on the threat value being less than the predefined threshold.

4. The method of claim 1, wherein determining the event based on the sensor information comprises determining, based on a machine learning model and the sensor information, the event based on the sensor information.

5. The method of claim 1, wherein determining context information comprises determining, based on a machine learning model and the one or more video frames, the context information.

6. The method of claim 1, wherein determining context information comprises at least one of:
identifying one or more persons within the one or more video frames;
identifying one or more attributes of one or more person within the one or more video frames;
identifying an activity being performed within the one or more video frames;
identifying an object within the one or more video frames;
identifying a number of objects within the one or more video frames; or identifying an environmental condition of a location within the one or more video frames.

7. The method of claim 1, wherein determining the context information comprises determining an operational status of the one or more video capture devices.

8. The method of claim 1, wherein the one or more sensors include occupancy sensors, environmental sensors, door sensors, entry sensors, exit sensors, people counting sensors, temperature sensors, liquid sensors, motion sensors, light sensors, carbon monoxide sensors, smoke sensors, gas sensors, location sensors, and/or pulse sensors.

9. A system comprising:
one or more video capture devices;
one or more sensors; and
a monitoring platform comprising:
a memory; and
at least one processor coupled to the memory and configured to:
receive sensor information from the one or more sensors, the sensor information indicating activity within a controlled environment;
determine an event based on the sensor information;
receive one or more video frames from the one or more video capture devices;
determine context information based on the one or more video frames;
modify the event by the context information to generate an alarm; and
transmit a notification identifying the alarm to a monitoring device.

10. The system of claim 9, wherein the event is a risk value, the context information is a dynamic value, and to modify the event, the at least one processor is configured to:
generate a threat value by adding the dynamic value to the risk value or subtracting the dynamic value from the risk value;
determine that the threat value is greater than a predefined threshold; and
generate the alarm based on the threat value being greater than the predefined threshold.

11. The system of claim 9, wherein the event is a risk value, the context information is a dynamic value, and to modify the event, the at least one processor is configured to:
generate a threat value by adding the dynamic value to the risk value or subtracting the dynamic value from the risk value;
determine that the threat value is less than a predefined threshold; and
clear the event based on the threat value being less than the predefined threshold.

12. The system of claim 9, wherein to determine the event based on the sensor information, the at least one processor is configured to:
determine, based on a machine learning model, the event based on the sensor information.

13. The system of claim 9, wherein to determine context information, the at least one processor is configured to:
determine, based on a machine learning model, the context information.

14. The system of claim 9, wherein to determine the context information, the at least one processor is configured to:
identify one or more persons within the one or more video frames;
identify one or more attributes of one or more person within the one or more video frames;
identify an activity being performed within the one or more video frames;
identify an object within the one or more video frames;
identify a number of objects within the one of more video frames; and/or identify an environmental condition of a location within the one or more video frames.

15. The system of claim 9, wherein to determine context information, the at least one processor coupled to the memory and configured to:
determine an operational status of the one or more video capture devices.

16. The system of claim 9, wherein the one or more sensors include occupancy sensors, environmental sensors, door sensors, entry sensors, exit sensors, people counting sensors, temperature sensors, liquid sensors, motion sensors, carbon monoxide sensors, smoke sensors, light sensors, gas sensors, location sensors, and/or pulse sensors.

17. A non-transitory computer-readable storage medium storing instructions that cause a processor to perform a method comprising:
receiving sensor information captured by one or more sensors, the sensor information indicating activity within a controlled environment;
determining an event based on the sensor information;
receiving one or more video frames from one or more video capture devices;
determining context information based on the one or more video frames;
modifying the event based on the context information to generate an alarm; and transmitting a notification identifying the alarm to a monitoring device.
